(19) United States
(12) Patent Application Publication
(10) Pub. No.: US 2022/0270779 A1
(43) Pub. Date: Aug. 25, 2022

(54) THERMALLY CONDUCTIVE LAMINATE

(71) Applicant: 3M INNOVATIVE PROPERTIES COMPANY, St. Paul, MN (US)

(72) Inventor: Kentaro TAMURA, Kanagawa (JP)

(21) Appl. No.: 17/628,768

(22) PCT Filed: Jul. 20, 2020
(86) PCT No.: PCT/IB2020/056806

§ 371 Date: Jan. 20, 2022

(30) Foreign Application Priority Data
Jul. 23, 2019 (JP) 2019-135350

(51) Int. Cl. H01B 1/12; B32B 27/28; B32B 27/30

(52) U.S. Cl. CPC H01B 1/12; B32B 27/283; B32B 27/308; B32B 2307/302; B32B 2307/536

(57) ABSTRACT

The thermally conductive laminate of an embodiment of the present disclosure includes a thermally conductive resin layer containing a thermally conductive raw material and a resin and having first and second major faces, and a porous base material provided on at least one of the first and second major faces of the thermally conductive resin layer, the porous base material being arranged in a proportion of approximately 75% or less relative to a total area of the major faces of the thermally conductive resin layer to which the base material was arranged.

### TECHNICAL FIELD The present disclosure relates to a thermally conductive component.

### BACKGROUND

For example, to efficiently cool down heat build-up of components constituting electronic devices (e.g. power transistor, thyristor) and integrated circuits (e.g. IC, LSI), heat dissipation characteristics of such a heat-generating component are enhanced by applying a thermally conductive sheet in a gap between the heat-generating component and a heat sink, such as a radiator plate or a housing.

Patent Document 1 (JP 5101862 B2) describes a thermally conductive sheet that is prepared by using a particular monomer composition and that has excellent thermal conductivity and flexibility.

Patent Document 2 (WO 2013/161766) describes a thermally conductive adhesive sheet having an adhesive layer containing thermally conductive particles and a base material, which is laminated on one face in a thickness direction of the adhesive layer and on which a plurality of through holes that pass through the thickness direction are formed, and a thermal conductivity is 0.3 W/m·K or greater.

### CITATION LIST

### Patent Documents

Patent Document 1: JP 5101862 B2

Patent Document 2: WO 2013/161766

### SUMMARY

### Technical Problem

In the case where flexibility of a thermally conductive sheet is poor, for example, in the case where a difference in protrusion and recess of a surface to which the thermally conductive sheet is applied is large or in the case where an application area is relatively large, excessive stress is applied to adjacent elements and substrate, and these may be damaged. Because of this, although more flexible thermally conductive sheets are demanded, problems occurred in which handleability is deteriorated as a thermally conductive sheet becomes more flexible due to tendency to exhibit adhesiveness.

For example, handleability may be enhanced if a porous base material such as nonwoven fabric, which is typically non-stretching and non-adhesive, is applied to the entire face of a flexible thermally conductive sheet having adhesiveness. However, when such a porous base material is applied to the entire face, a flexible resin layer of the thermally conductive sheet is bound. For example, because force applied at the time of adhering of a heat-generating component and a heat-dissipating component cannot be released, the internal stress is accumulated in the thermally conductive sheet, and this may break, for example, an element.

The present disclosure provides a thermally conductive laminate having excellent handleability without applying excessive stress onto an element or the like.

### Solution to Problem

According to an embodiment of the present disclosure, provided is a thermally conductive laminate including a thermally conductive resin layer containing a thermally conductive raw material and a resin and having first and second major faces, and a porous base material provided on at least one of the first and second major faces of the thermally conductive resin layer, the porous base material being arranged in a proportion of approximately 75% or less relative to a total area of the major faces of the thermally conductive resin layer to which the base material was arranged.

According to another embodiment of the present disclosure, provided is a thermally conductive laminate comprising a thermally conductive resin layer containing a thermally conductive raw material and a resin and having first and second major faces, and a porous base material provided on at least one of the first and second major faces of the thermally conductive resin layer, a compression ratio at 30% compression being approximately 260% or less.

### Advantageous Effects of Invention

According to the present disclosure, a thermally conductive laminate having excellent handleability without applying excessive stress onto an element or the like can be provided.

The above description will not be construed to mean that all embodiments of the present invention and all advantages of the present invention are disclosed.

### BRIEF DESCRIPTION OF THE DRAWINGS

FIG. 1(a) is a cross-sectional view of a thermally conductive laminate before compression, in which non-stretchable porous base materials are applied to the both faces of the thermally conductive resin layer. FIG. 1(b) is a schematic view of a condition where the thermally conductive laminate of the configuration described above is inserted in between a heat-dissipating component and a heat-generating component and adhered by applying pressure.

FIG. 2(a) is a cross-sectional view of a thermally conductive laminate according to an embodiment of the present disclosure before compression, in which porous base materials are partially applied to the both faces of the thermally conductive resin layer.

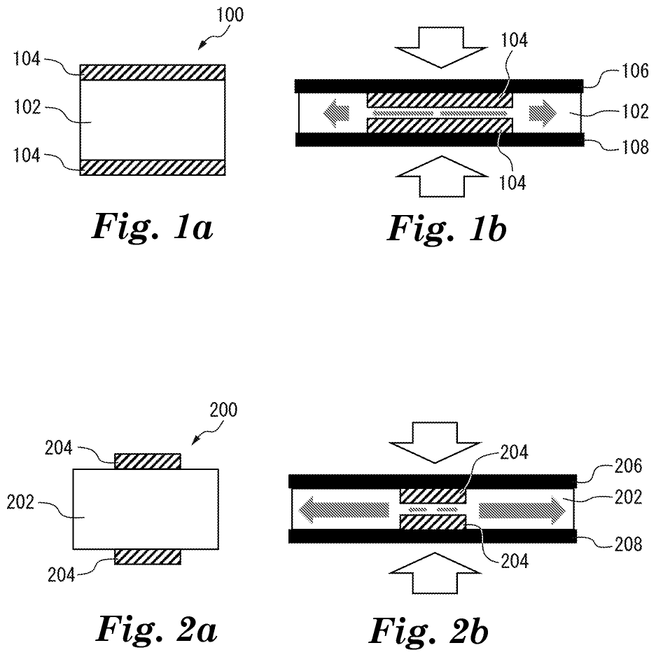

FIG. 1(b) is a schematic view of a condition where the thermally conductive laminate of the configuration described above is inserted in between a heat-dissipating component and a heat-generating component and adhered by applying pressure.

FIG. 3 is a perspective view of a thermally conductive laminate according to an embodiment of the present disclosure.

FIG. 4 is a perspective view of a thermally conductive laminate according to another embodiment of the present disclosure.

FIG. 5(a) is a perspective view of a thermally conductive laminate according to another embodiment of the present disclosure. FIG. 5(b) is a photograph before and after pulling a porous base material having stretchability according to one embodiment of the present disclosure.

FIG. 6(a) is a plane view of the porous base material having cuts in a form of broken line of an embodiment of the present disclosure. FIG. 6(b) is a plane view of the porous base material having cuts in a form of broken line of another embodiment of the present disclosure.

### DETAILED DESCRIPTION

Although representative embodiments of the present invention will now bdescribed in greater detail for the purpose of illustration with reference to the drawings, the present invention is not limited to these embodiments. As for the reference signs in the drawings, elements denoted by the similar reference signs in different drawings indicate similar or corresponding elements.

In the present disclosure, for example, “on” in “a porous base material provided on at least one of the first and second major faces of the thermally conductive resin layer” means that the porous base material is directly arranged on the major face of the thermally conductive resin layer or that the porous base material is indirectly arranged on the major face of the thermally conductive resin layer, with another layer such as a bonding layer interposed between the porous base material and the major face.

In the present disclosure, “(meth)acrylic” means acrylic or methacrylic, and “(meth)acrylate” means acrylate or methacrylate.

In the present disclosure, the term “substantially” refers to including variations caused by for instance manufacturing errors, and is intended to mean that approximately ±20% variation is acceptable.

A thermally conductive laminate of the present disclosure will be described below with reference to the drawings.

FIG. 1(a) is a cross-sectional view of a thermally conductive laminate 100, in which a non-stretchable porous base materials 104 are applied to both major faces of a thermally conductive resin layer 102. In this thermally conductive laminate 100, the porous base materials 104 are applied to the major faces of the thermally conductive resin layer 102 exhibiting adhesiveness, and thus excellent handleability is achieved because the adhesiveness is not exhibited on the thermally conductive laminate surfaces with a degree of pressure applied by handling with human hands.

When this thermally conductive laminate is inserted in between, for example, a heat-dissipating component 106 and a heat-generating component 108, and pressure is applied from the outside (arrow outline with a blank inside) as illustrated in FIG. 1(b), the porous base materials 104 on the both major faces are embedded in the thermally conductive resin layer 102, and the resin of the thermally conductive resin layer 102 appears on the surface of the thermally conductive laminate through holes of the porous base materials 104, and thus adhesiveness between the heat-dissipating component 106 and the heat-generating component 108 and thermal conductivity can be exhibited.

However, because the thermally conductive resin layer 102 is bound by the non-stretchable porous base materials 104 for its entire faces, the thermally conductive laminate with this configuration is in a condition where the thermally conductive resin layer between the porous base materials is less likely to be stretched as illustrated by thin arrows between the porous base materials in FIG. 1(b). As a result, the thermally conductive laminate with this configuration easily increases internal stress due to not being capable of releasing the force applied from the outside (this phenomenon may be hereinafter simply referred to as “stress increase”), and may apply excessive load (stress) onto the heat-dissipating component and the heat-generating component.

On the other hand, by arranging a porous base material in a proportion of approximately 75% or less relative to a total area of the major faces of the thermally conductive resin layer or by employing a porous base material having a stretchability in the case where the porous base material is arranged in a proportion of greater than approximately 75% relative to a total area of the major faces of the thermally conductive resin layer, the thermally conductive laminate of the present disclosure can reduce or prevent stress increase while handleability is enhanced.

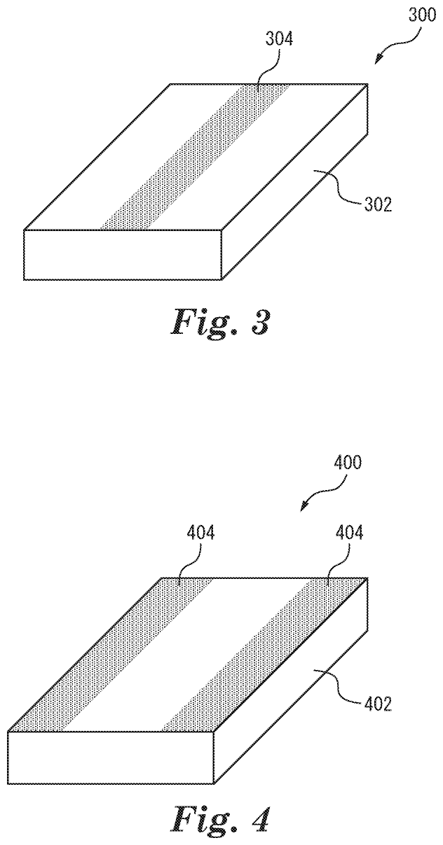

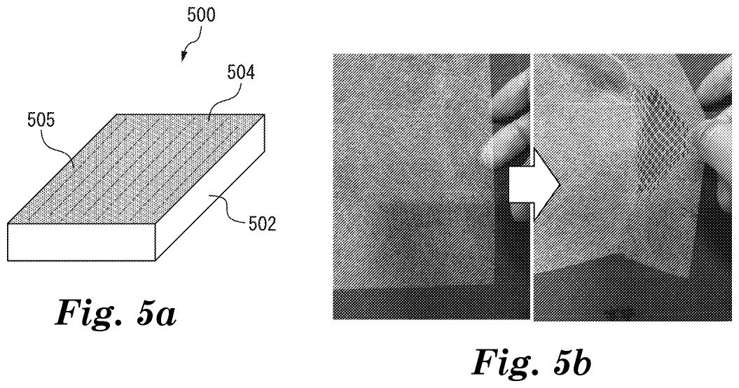

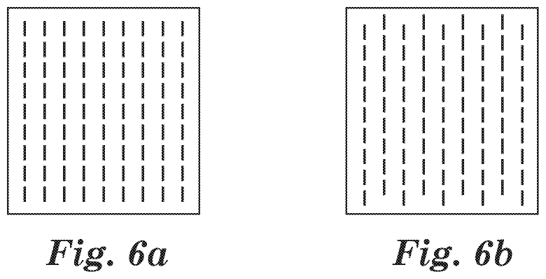

FIG. 2(a) is a cross-sectional view related to a thermally conductive laminate 200 according to an embodiment of the present disclosure. As illustrated in FIG. 3, this thermally conductive laminate 200 has a configuration in which the porous base materials 204 are arranged substantially symmetrical and linear in substantially central parts of the both major faces of the thermally conductive resin layer 202. In this thermally conductive laminate 200, the porous base materials 204 are partially arranged on the major faces of the thermally conductive resin layer 202 exhibiting adhesiveness, and thus excellent handleability can be achieved because the adhesiveness is not exhibited on the thermally conductive laminate surfaces with a degree of load applied by handling with human hands in the arranged positions of the porous base materials.

When this thermally conductive laminate is inserted in between, for example, a heat-dissipating component 206 and a heat-generating component 208, and pressure is applied from the outside similarly to FIG. 1, the porous base materials 204 on the both major faces are embedded in the thermally conductive resin layer 202 and the resin of the thermally conductive resin layer 202 appears on the surface of the thermally conductive laminate through holes of the porous base materials 204, and thus adhesiveness between the heat-dissipating component 206 and the heat-generating component 208 and thermal conductivity can be exhibited.

In the thermally conductive laminate with this configuration, the thermally conductive resin layer 202 is less likely to be bound by the porous base materials 204 compared to the case of the thermally conductive laminate having the configuration of FIG. 1, and the force applied from the outside tends to be released without being built-up inside. Therefore, load onto, for example, a heat-dissipating component and a heat-generating component can be reduced or prevented.

To exemplify representative embodiments of the present disclosure, details of the structural components recited above are described below with some of the reference signs being omitted.

The thermally conductive laminate of the present disclosure has a thermally conductive resin layer that contains a thermally conductive raw material and a resin and that has first and second major faces.

The resin constituting the thermally conductive resin layer of the present disclosure is not particularly limited. For example, the thermally conductive resin layer may use a resin material having flexibility, such that a resin material that can exhibit the Asker C hardness described below, such as a (meth)acrylic resin or a silicone-based raw material. The (meth)acrylic resin and the silicone-based raw material are described below.

The (meth)acrylic resin is not particularly limited and, for example, can be prepared by using a photopolymerizable component containing a (meth)acrylic monomer or a partial polymer thereof, and a composition containing a photoreaction initiator to initiate polymerization of this photopolymerizable component. The photopolymerizable component can be referred to as “binder component” because the photopolymerizable component also serves as a binder in the composition. The photopolymerizable component contains a (meth)acrylic monomer or a partial polymer thereof, and the details thereof are not particularly limited. For example, as the (meth)acrylic monomer, a (meth)acrylic monomer containing an alkyl group having 20 or less carbon atoms can be used. Specific examples thereof include ethyl (meth)acrylate, butyl (meth)acrylate, hexyl (meth)acrylate, 2-ethylhexyl (meth)acrylate, octyl (meth)acrylate, isooctyl (meth)acrylate, decyl (meth)acrylate, dodecyl (meth)acrylate, lauryl (meth)acrylate, and isostearyl (meth)acrylate.

To increase cohesive force of the obtained thermally conductive resin layer, for example, a (meth)acrylic monomer having a glass transition temperature of homopolymer of 20° C. or higher and/or a polyfunctional (meth)acrylate can be used together.

Examples of the (meth)acrylic monomer having a glass transition temperature of homopolymer of 20° C. or higher include carboxylic acids and corresponding anhydrides, such as acrylic acid and anhydrides thereof, methacrylic acid and anhydrides thereof, itaconic acid and anhydrides thereof, and maleic acid and anhydrides thereof. Other examples of the (meth)acrylic monomer having a glass transition temperature of homopolymer of 20° C. or higher include substituted (meth)acrylamides, such as cyanoalkyl (meth)acrylate, (meth)acrylamide, and N,N′-dimethyl(meth)acrylamide, and polar nitrogen-containing raw materials, such as N-vinylpyrrolidone, N-vinylcaprolactam, N-vinylpiperidine, and acrylonitrile. Examples of yet another monomer include tricyclodecyl (meth)acrylate, isobornyl (meth)acrylate, hydroxy (meth)acrylate, and vinyl chloride.

Examples of polyfunctional (meth)acrylate include trimethylolpropane tri(meth)acrylate, pentaerythritol tetra(meth)acrylate, 1,2-ethylene glycol di(meth)acrylate, and 1,6-hexane diol di(meth)acrylate.

From the perspective of, for example, flexibility of the resulting thermally conductive resin layer relative to the total amount of the photopolymerizable component, it is advantageous for the photopolymerizable component to contain approximately 98 mass % or greater of alkyl (meth)acrylic monomer having a glass transition of the homopolymer of −40° C. or lower. The alkyl (meth)acrylic monomer is not particularly limited to the following, and examples thereof include n-butyl (meth)acrylate, 2-ethylhexyl (meth)acrylate, and isooctyl (meth)acrylate.

The photopolymerizable component may contain a partial polymer of the (meth)acrylic monomer, as necessary. When thermally conductive fillers, which are thermally conductive raw materials, are mixed in the photopolymerization component, the partial polymer of the (meth)acrylic monomer can prevent sedimentation of the fillers in the resulting composition. That is, by subjecting a part of a (meth)acrylic monomer to partial polymerization in advance, filler sedimentation caused by thickening effect can be prevented. From the perspective of, for example, sedimentation resistance of fillers, the compounded amount of the partial polymer of the (meth)acrylic monomer is preferably approximately 5 mass % or greater relative to the total amount of the composition (solid content). The upper limit of the compounded amount of the partial polymer is not particularly limited but, for example, can be approximately 20 mass % or less. When the partial polymer is contained in the composition in such a range, the viscosity of the composition can be adjusted to approximately 100 to approximately 10000 centipoise (cP). The partial polymerization of the (meth)acrylic monomer can be performed by any method, such as thermal polymerization, ultraviolet polymerization, or electron beam polymerization.

As the photopolymerizable component, one of the components described above can be used alone, or two or more of the components described above can be used in combination. The compounded amount of the photopolymerizable component is not particularly limited, and can be adjusted based on desired flexibility and thermal conductivity. For example, the compounded amount of the photopolymerizable component can be approximately 5 mass % or greater, approximately 6 mass % or greater, or approximately 7 mass % or greater, and can be approximately 30 mass % or less, approximately 25 mass % or less, or approximately 20 mass % or less, relative to the total amount of the composition in terms of solid content. The photoreaction initiator to initiate the polymerization of the photopolymerizable component is not particularly limited. A known photoreaction initiator can be used alone, or two or more known photoreaction initiators can be used in combination. For example, a phosphone oxide-based compound having light absorption performance in a wavelength region of approximately 400 to approximately 450 nm can be used as the photoreaction initiator. Examples of the phosphone oxide-based compound include bis(2,4,6-trimethylbenzyl)phenylphosphine oxide and 2,4,6-trimethylbenzyl diphenylphosphine oxide.

The compounded amount of the photoreaction initiator is not particularly limited and, for example, can be approximately 0.05 parts by mass or greater, or approximately 0.1 parts by mass or greater, and can be approximately 1.0 part by mass or less, or approximately 0.6 parts by mass or less, per 100 parts by mass of the photopolymerizable component from the perspectives of, for example, reaction conversion rate and cohesive force.

Optionally, a light absorber can be blended in the composition. For example, the light absorber can be used to absorb and remove a predetermined band of wavelength from ionizing radiation (e.g. ultraviolet radiation) used to polymerize the photopolymerizable component. In particular, a light absorber that can remove a short wavelength ultraviolet region (S-UV) included in ultraviolet radiation from the ultraviolet radiation can enhance cohesive force around the surface of the thermally conductive resin layer. Here, the short wavelength ultraviolet region (S-UV) typically means an ultraviolet band region having a wavelength shorter than approximately 345 nm.

Examples of the light absorber that can remove a wavelength band that is shorter than approximately 345 nm from the ultraviolet radiation (ultraviolet absorber) include triazine-based compounds. As the triazine-based compound, for example, a UV absorber of TINUVIN (trade name) series, available from BASF Japan Ltd., such as TINUVIN (trade name) 400 and TINUVIN (trade name) 405, can be used.

The compounded amount of the light absorber is not particularly limited and, for example, can be approximately 0.5 parts by mass or greater, or approximately 1 part by mass or greater, and can be approximately 6 parts by mass or less, or approximately 5 parts by mass or less, per 100 parts by mass of the photopolymerizable component from the perspectives of, for example, reaction conversion rate and cohesive force.

In addition, various additives used in the field of thermally conductive sheet can be optionally blended in the component, and such additives can be used alone or as a combination of two or more thereof. Examples of suitable additives include antioxidants, metal deactivators, plasticizers (e.g. diisononyl adipate, diisodecyl adipate, tetraethylene glycol-di-2-ethylhexanoate), flame retardants, adhesion imparting agents, antisettling agents, thixotropy agents, surfactants, antifoaming agents, coloring agents, antistatic agents, and solvents (organic solvents, water-based solvents).

The silicone-based raw material is not particularly limited and, for example, silicone gel or silicone rubber can be used.

Any silicone gel, such as thermosetting silicone gel or cold curing silicone gel, silicone gel having condensation type curing mechanism or addition type curing mechanism, can be used. From the perspectives of, for example, ease in adjusting crosslinking density and ease in achieving flexibility, silicone gel obtained from an addition type silicone composition is preferred. The group bonded to a silicon atom is not particularly limited, and examples thereof include alkyl groups, such as a methyl group, an ethyl group, and a propyl group, cycloalkyl groups, such as a cyclopentyl group and a cyclohexyl group, alkenyl groups such as a vinyl group and an allyl group, aryl groups such as a phenyl group and a tolyl group, and groups in which hydrogen atoms of these groups are partially substituted by other atoms or linking groups.

The production method of addition reaction type (or crosslinking) silicone gel is not particularly limited. The addition reaction type (or crosslinking) silicone gel can be typically obtained by using an organohydrogenpolysiloxane (a-1) and an alkenylpolysiloxane (a-2) as raw materials and subjecting these to hydrosilylation reaction (addition reaction) in the presence of addition reaction catalyst (a-3). An addition reaction curable silicone gel composition that can form such a silicone gel includes two types, which are one-part curing and two-part curing types, and one-part curable composition can provide a flexible gel by heating the composition, and two-part curable composition can provide a flexible gel by subjecting the two parts to mixing and then heating.

As the addition reaction catalyst (a-3), any catalyst known to promote addition reaction (hydrosilylation reaction) of an alkenyl group bonded to a silicon atom in the component (a-1) and a hydrogen atom bonded to a silicon atom in the component (a-2). For example, platinum-based catalysts, such as chloroplatinic acid, alcohol-modified chloroplatinic acid, complexes of chloroplatinic acid and vinylsiloxane, and chloroplatinic acid-2-ethylhexanol solutions, palladium-based catalysts, such as tetrakis(triphenylphosphine)palladium and mixtures of palladium black and triphenylphosphine, and platinum group metal-based catalysts, such as rhodium catalysts, can be used.

The compounded amount of the addition reaction catalyst (a-3) can be appropriately adjusted taking, for example, reactivity into consideration. For example, the addition reaction catalyst (a-3) can be used in a range of approximately 0.1 ppm to approximately 100 ppm (in terms of catalyst metal element) relative to the total amount of the component (a-1) and the component (a-2).

For the silicone gel, the flexibility of the silicone gel can be adjusted by changing the crosslinking density of the silicone gel by appropriately adjusting, for example, compounded proportions of (a-1) to (a-3), and temperature and duration of crosslinking.

For example, the silicone gel may exhibit desired adhesiveness by blending an MQ resin-type adhesion-imparting component, adding an unreactive adhesive component, or adjusting the length of a side chain of an uncrosslinked functional group and type of terminal functional group.

As the silicone rubber, any addition reaction type or condensation type silicone rubber can be used. As the addition reaction type silicone rubber, a silicone rubber exhibiting rubber elasticity (property that allows elongation when a load is applied and returns to substantially initial position when the load is removed) as a result of increasing the crosslinking density of the addition reaction type silicone gel described above can be used. The condensation type silicone rubber is a silicone rubber crosslinked by causing hydrolysis-condensation reaction as a result of the reaction with moisture in the air. Examples of the hydrolysis functional group contained in this condensation type reactive silicone rubber include alkoxy groups (dealcoholization type), isopropenoxy group (deacetone type), methyl ethyl ketoxime group (deoxime type), and acetoxy group (deacetic acid type). From the perspectives of fast curing rate and less odor of substance to be released, deacetone type or dealcoholization type is preferred.

For preparation of the silicone-based raw material, various additives used in the field of thermally conductive sheet can be optionally used alone or in combination of two or more thereof. Examples of suitable additives include antioxidants, metal deactivators, plasticizers, flame retardants, adhesion imparting agents, antisettling agents, thixotropy agents, surfactants, antifoaming agents, coloring agents, antistatic agents, and solvents (organic solvents, water-based solvents).

The thermally conductive raw material blended in the thermally conductive resin layer of the present disclosure is not particularly limited and may be insulating or electrically conductive. These thermally conductive raw materials can use one or a combination of two or more of the following raw materials.

Examples of the insulating thermally conductive raw material include nitrogen compounds, such as boron nitride, aluminum nitride, and silicon nitride; metal oxides, such as aluminum oxide (alumina), magnesium oxide, zinc oxide, silicon oxide, beryllium oxide, titanium oxide, copper oxide, and cuprous oxide; metal hydroxides, such as magnesium hydroxide and aluminum hydroxide; carbon compounds, such as silicon carbide and diamond; minerals, such as talc, mica, kaolin, bentonite, magnesite, and pyrophyllite; ceramics, such as titanium boride and calcium titanate. Note that boron nitride may have any structure, such as c-BN (cubic structure), w-BN (wurtzite structure), h-BN (hexagonal structure), r-BN (rhombohedral structure), or t-BN (turbostratic structure). The shape of boron nitride includes scale-like and aggregation of these, any of these can be used.

Among these, from the perspectives of thermal conductivity and cost, aluminum oxide, aluminum hydroxide, zinc oxide, boron nitride, and aluminum nitride are preferred, aluminum oxide and aluminum hydroxide are more preferred, and aluminum hydroxide is particularly preferred.

As the electrically conductive thermally conductive raw material, carbon compounds, such as graphite, carbon black, graphite, carbon fibers (pitch-based, PAN-based), carbon nanotubes (CNT), and carbon fibers (CNF), metals, such as silver, copper, iron, nickel, aluminum, and titanium, or metal alloy containing these, stainless steel (SUS), electrically conductive metal oxides, such as zinc oxide to which different type of element is doped, and metal-based compounds, such as ferrites, can be used. An insulating raw material, such as silica, may be coated with an electrically conductive thermally conductive raw material to make it electrically conductive, or an electrically conductive thermally conductive raw material may be coated with an insulating raw material, such as silica, to make it insulating, and these may be used as the thermally conductive raw materials.

The form of the thermally conductive raw material is not particularly limited, and examples thereof include fiber-like, plate-like, scale-like, stick-like, granular (spherical), rod-like, tube-like, curved plate-like, needle-like, and needle-like. These thermally conductive raw materials may be subjected to surface treatment, such as silane coupling treatment, titanate coupling treatment, epoxy treatment, urethane treatment, and oxidizing treatment.

The size of the thermally conductive raw material is not particularly limited, and can be appropriately selected taking, for example, thermal conductivity and flexibility into consideration. For example, the size of the thermally conductive raw material can be approximately 0.3 μm or greater, approximately 0.5 μm or greater, or approximately 1 μm or greater, and can be approximately 500 μm or less, approximately 250 μm or less, approximately 150 μm or less, approximately 100 μm or less, approximately 80 μm or less, or approximately 60 μm or less. The size (average particle diameter) of the thermally conductive raw material can be measured by using a dynamic light scattering method for the composition containing the thermally conductive raw material.

The thermally conductive raw material is typically mixed with the resin component described above and optional components, and used as a form of a composition. The content of the thermally conductive raw material in the thermally conductive resin layer of the present disclosure is not particularly limited, and can be appropriately adjusted based on desired flexibility and thermal conductivity. For example, the content of the thermally conductive raw material can be approximately 20 mass % or greater, approximately 30 mass % or greater, approximately 40 mass % or greater, approximately 50 mass % or greater, or approximately 55 mass % or greater, and can be approximately 95 mass % or less, approximately 93 mass % or less, or approximately 90 mass % or less, in terms of solid content, relative to the total mass of the composition constituting the thermally conductive resin layer. Alternatively, the content can be approximately 20 vol % or greater, approximately 30 vol % or greater, approximately 40 vol % or greater, approximately 50 vol % or greater, or approximately 55 vol % or greater, and can be approximately 90 vol % or less, approximately 80 vol % or less, or approximately 70 vol % or less, in terms of solid content, relative to the total volume of the composition constituting the thermally conductive resin layer.

The production method of the thermally conductive resin layer of the present disclosure is not particularly limited, and a known method can be used. For example, a composition for forming the thermally conductive resin layer is prepared by charging the resin component, the thermally conductive raw material, and optional components described above in a mixing device, such as a planetary mixer, or a kneading device. The thermally conductive resin layer can be prepared by using the obtained composition, for example, by a method such as a coating method, a printing method, an extrusion molding method, a calender molding method, an injection molding method, or a 3D printing method.

For example, in the case where the thermally conductive resin layer is prepared by using a coating method, the composition for forming the thermally conductive resin layer is coated on a support having releasability or having been undergone release treatment in a predetermined thickness, and optionally subjected to, for example, a drying process, ionizing radiation curing process, or heat curing process, and thus the thermally conductive resin layer can be prepared. Note that, as the support, for example, a resin film such as a polyester film (e.g. polyethylene terephthalate film), paper, or metal foil can be used. In the case where ionizing radiation curing process is employed, it is advantageous to use a transparent support, such as polyester film. Furthermore, as a coating means, for example, die coating, roller coating, kiss coating, gravure coating, knife coating, bar coating, comma coating, or curtain coating can be used.

The thermally conductive resin layer may have a single layer structure or a laminate structure. The thermally conductive resin layer may have a protruded and recessed shape corresponding to the shape of an adherend, that is, may have an irregular shape. From the perspective of, for example, cost, use in a form of, typically, a substantially flat film, sheet, or plate is preferred. Because the flexible thermally conductive resin layer can conform to the protruded and recessed shape of an adherend, the thermally conductive resin layer can cope with various adherends even when the thermally conductive resin layer has a substantially flat shape. The flat shape is not particularly limited and, for example, can be substantially circular, substantially square, substantially rectangular (substantially oblong).

The thickness of the thermally conductive resin layer is not particularly limited, and can be appropriately adjusted depending on, for example, production capability, handleability, and use. For example, the thickness of the thermally conductive resin layer having a substantially flat shape can be approximately 0.1 mm or greater, approximately 0.5 mm or greater, approximately 0.7 mm or greater, or approximately 1.0 mm or greater, and can be approximately 10 mm or less, approximately 7.0 mm or less, approximately 5.0 mm or less, or approximately 2.5 mm or less. The thickness of the thermally conductive resin layer can be defined as an average value calculated by measuring the thickness of freely selected portion of the thermally conductive resin layer for at least five times by using High-Accuracy Digimatic Micrometer (MDH-25MB, available from Mitutoyo Corporation).

The thermally conductive resin layer of the present disclosure may have a hardness measured by an Asker C hardness tester of approximately 15 or less, approximately 12 or less, or approximately 10 or less, and can be greater than approximately 0, approximately 0.1 or greater, approximately 0.5 or greater, or approximately 1.0 or greater, in the case where the raw material constituting the resin layer is formed into a sheet having a thickness of 10 mm. The thermally conductive resin layer having the Asker C hardness within such a range has excellent flexibility, and thus can reduce or prevent stress increase involved in compression, increase the contact area with the adherend, and enhance protrusion and recess conformability (gap filling characteristics). Note that, as the sheet having a thickness of 10 mm during the Asker C hardness measurement, an integrated sheet having a thickness of 10 mm may be used, or a sheet obtained by laminating a plurality of thin sheets to make the thickness 10 mm may be used.

In the thermally conductive laminate of the present disclosure, a porous base material is arranged on at least one of the first and second major faces of the thermally conductive resin layer. From the perspective of, for example, handleability, the porous base material is preferably arranged on both of the first and second major faces of the thermally conductive resin layer. The porous base material may be directly arranged on the thermally conductive resin layer or may be indirectly arranged on the thermally conductive resin layer with, for example, an adhesive agent is interposed between the porous base material and the thermally conductive resin layer. From the perspectives of, for example, reduction or suppression of stress increase, productivity, and infiltration property of resin from the thermally conductive resin layer, the porous base material is preferably directly arranged on the thermally conductive resin layer.

The porous base material is not particularly limited as long as the porous base material is a base material having through holes, that is, a base material, with which the resin of the thermally conductive resin layer positioned below the base material can appear on the base material surface through holes of the base material when pressure is applied to the porous base material. Examples of such a porous base material include porous base materials in which through holes are provided on a base material, such as a resin film or metal foil; mesh-like base materials (net-like or grid-like base materials); fabric base materials, such as knit fabric, woven fabric, and non-woven fabric; and paper base materials. These may be used alone or in combination of two or more of them.

The raw material constituting the porous base material is not particularly limited and, for example, one or a combination of two or more of resin materials, rubber materials (elastomer materials), metal materials, inorganic materials, and/or natural fiber materials can be used. Among these, a resin material is preferred from the perspectives of, for example, cost and stretchability.

The metal material is not particularly limited and, for example, one or a combination of two or more of copper, aluminum, iron, and alloys thereof can be used.

The resin material is not particularly limited and, for example, one or a combination of two or more of polyolefin resins such as polyethylene and polypropylenes, polyester resins such as polyethylene terephthalate, and polyamide resins can be used.

The rubber material is not particularly limited and, for example, one or a combination of two or more of vulcanized rubbers such as natural rubbers and synthetic rubbers; thermoplastic elastomers such as urethane rubbers, silicone rubbers, and fluororubbers; and olefin-based, polystyrene-based, polyvinyl chloride-based, polyurethane-based, polyester-based, or polyamide-based thermoplastic elastomers.

The inorganic material is not particularly limited and, for example, one or a combination of two or more of glass-based materials such as glass fibers, ceramic materials such as ceramic fibers, and carbon-based materials such as carbon fibers can be used.

The natural fiber material is not particularly limited and, for example, one or a combination of two or more of cotton, wool, hemp, silk, pulp fiber, and bamboo fiber can be used. In addition, cellulose contained in natural fibers, regenerated fibers prepared by using proteins, and semi-synthetic fibers can be also used.

The basis weight of the porous base material is not particularly limited and, for example, can be approximately 1.0 g/m² or greater, approximately 3.0 g/m² or greater, or approximately 5.0 g/m² or greater, and can be approximately 20 g/m² or less, approximately 17 g/m² or less, or approximately 15 g/m² or less, from the perspectives of, for example, thermal conductivity, reduction or suppression of stress increase, and handleability.

In some embodiments, the porous base material can be partially arranged on at least one of the major faces of the thermally conductive resin layer. In the case where the porous base material is partially arranged, from the perspectives of, for example, reduction or prevention of stress increase and handleability, the porous base material is preferably arranged in a proportion of approximately 75% or less, approximately 70% or less, or approximately 65% or less, relative to the total area of the major faces of the thermally conductive resin layer, to which the porous base material is arranged. The lower limit of the arrangement proportion is not particularly limited, but can be approximately 1% or greater, approximately 3% or greater, or approximately 5% or greater. In the case where such an arrangement proportion is applied, any raw materials described above can be used as the raw material of the porous base material. In the case where the porous base materials are applied to the both faces of the thermally conductive resin layer in such an arrangement proportion, the porous base material on each face may be symmetrically arranged or asymmetrically arranged via the thermally conductive resin layer. Stretchability may be imparted to the porous base material by forming cuts described below, for example.

The arrangement form in the case where the porous base material is partially arranged is not particularly limited as long as the porous base material is arranged on the thermally conductive resin layer in the arrangement proportion described above. For example, from the perspectives of thermal conductivity, reduction or suppression of stress increase, handleability, and productivity, as illustrated in FIG. 3, the porous base material may be arranged at at least a substantially central part of a major face of the thermally conductive resin layer, to which the base material is arranged. Alternatively, as illustrated in FIG. 4, the porous base materials may be arranged separately at two positions on at least substantially peripheral parts of a major face of the thermally conductive resin layer, to which the base materials are arranged. Alternatively, arrangement form having a combination of these arrangements, that is, a configuration where two or more, or three or more, of the porous base materials are arranged in a stripe form, may be employed. The porous base materials exemplified in FIG. 3 and FIG. 4 are arranged from an edge to another edge in the long side of the thermally conductive resin layer; however, the porous base materials do not need to be arranged from an edge to another edge.

In the case where pressure is applied onto the thermally conductive resin layer from the outside (e.g. from above and/or bottom of FIG. 3), it was found that the internal stress tends to remain in the peripheral parts rather than the central part of the resin layer. This tendency is notable, in particular, in the case where the thermally conductive laminate has a large area, such as 50 cm² or greater, 100 cm² or greater, or 150 cm² or greater. Therefore, in the case where the porous base material is partially arranged on at least one of the major faces of the thermally conductive resin layer, especially in the case where the thermally conductive laminate has a large area, from the perspective of reduction or suppression of stress increase, as illustrated in FIG. 3, it is advantageous to arrange the porous base material in a substantially central part in the long side direction of the thermally conductive resin layer without arranging the porous base material in both edge parts in the long side direction, or arrange the porous base material in a substantially central part in the short side direction of the thermally conductive resin layer without arranging the porous base material in both edge parts in the short side direction. Taking, for example, productivity into consideration, it is advantageous for the porous base material to be arranged to have a substantially linear form as illustrated in FIG. 3.

In some embodiments, as long as the porous base material is a porous base material having stretchability, the base material can be partially arranged in a proportion of greater than approximately 75% or arranged on the entire face of the total area of the major faces of the thermally conductive resin layer, to which the base material is arranged, on at least one of the major faces of the thermally conductive resin layer.

The stretchability of the porous base material can be evaluated by, for example, elongation at break. For example, from the perspectives of reduction or suppression of the stress increase and restorability of dimension (reworkability), the elongation at break can be approximately 120% or greater, approximately 150% or greater, approximately 180% or greater, or approximately 200% or greater. The upper limit of the elongation at break is not particularly limited and, for example, can be approximately 5000% or less, approximately 4000% or less, or approximately 3000% or less.

The elongation at break of the porous base material can be determined in accordance with JIS L 1913 in a condition where a sample width is 25 mm, a grip spacing is 25 mm, and pulling speed is 300 mm/min. Specifically, a sample of a dried porous base material obtained by drying at 40° C. for 72 hours in a drying oven was prepared. A test piece having a width of 25 mm and a length of 75 mm was cut out from the sample, and regions from both edges to 25 mm in the length direction were sandwiched by two pieces of fixing tape having a width of 25 mm and a length of 30 mm (Scotch (trade name) Premium Grade Filament Tape, model “898, width 25 mm”, available from 3M Company). The produced test piece is fixed without tension on Tensilon Tester (model: RTG-1225, available from Orientec Corporation) in a manner that distance between chucks is 25 mm. The shape of the chuck has a width of 25 mm or greater and a height of 25 mm or greater. At this time, the fixing tape of the test piece is fixed to operation chucks in a manner that the fixing tape does not stick out from the bottom end of the operation chuck located on the top side. Tensile testing is performed by moving the operation chucks vertically upward at a speed of 300 mm/min to record the elongation at break (%). As the breaking point, a point where a load becomes 0.2 N or less is detected. The elongation at break is obtained by measuring at least five test pieces cut out from the same porous base material sample, and the average value thereof is used as the elongation at break. Note that, for the porous base material, to which cuts are formed and which exhibits stretchability, the test was performed in the direction in which the porous base material stretches the most. For example, in the case of the porous base material illustrated in FIG. 5, the test is performed for a substantially vertical direction (horizontal direction in FIG. 5(b)) relative to the line of broken line-like (perforation-like) cuts.

For the porous base material in this embodiment, any of the raw materials described above can be used. In the case where a raw material having no stretchability, other than raw materials having stretchability such as rubber material, is used, stretchability has only to be exhibited by, for example, forming cuts (e.g. broken line-like cuts) in the porous base material or by appropriately adjusting weave or fold.

From the perspectives of, for example, stretchability, cost, and productivity, a porous base material on which broken line-like cuts are provided as illustrated in FIG. 5, is preferably used. In FIG. 5, the broken line-like cuts 505 of the porous base material 504 are provided substantially parallel to the long side direction of the rectangular thermally conductive resin layer 502, but the broken line-like cuts 505 may be provided substantially parallel to the short side direction.

The cuts applied to the porous base material typically forms grid-like holes formed when this base material is stretched, such as the grid-like holes shown in the photograph of right side of FIG. 5(b). The shape, size, spacing, and the like of the cuts are not particularly limited, and can be appropriately adjusted taking, for example, desired stretchability and strength into consideration. For example, the length of cuts can be approximately 1 mm or greater, approximately 3 mm or greater, or approximately 5 mm or greater, and can be approximately 20 mm or less, approximately 15 mm or less, or approximately 10 mm or less.

The pitch distance between a line of cuts arranged substantially linearly and an adjacent line of cuts arranged substantially linearly is not particularly limited. From the perspectives of, for example, stretchability and strength, the pitch distance can be, for example, approximately 0.5 mm or greater, approximately 1.0 mm or greater, or approximately 1.5 mm or greater, and can be approximately 20 mm or less, approximately 15 mm or less, or approximately 10 mm or less.

As described above, in the case where pressure is applied to the thermally conductive resin layer from the outside (e.g. from above and/or bottom of FIG. 5), the resin layer tends to be stretched in the peripheral parts rather than the central part. Therefore, the cuts applied to the porous base material has only to be formed at least around peripheral part of the porous base material in a manner that stretching of the resin layer is not restricted, and do not need to be formed around a substantially central part. For example, in a porous base material applied to a substantially entire face, cuts may be provided in a region where the porous base material 404 is applied as illustrated in FIG. 4.

The region of the substantially central part to which cuts are not provided (e.g. region between a line of cuts positioned in an innermost side from an edge part of a first side and a line of cuts positioned in an innermost side from an edge part of a second side) can be, for example, approximately 50% or less, approximately 45% or less, or approximately 40% or less, and can be approximately 10% or greater, approximately 15% or greater, or approximately 20% or greater, relative to the entire porous base material.

A means for forming the cuts is not particularly limited, and a known method can be used. For example, in the case where broken line-like cuts are formed, a cutting device, in which a plurality of roll blades are arranged in the transverse direction (TD) that is substantially vertical to the machine direction (MD) and the circumference of each roll blade has cutting parts and non-cutting parts (e.g. recessed parts) corresponding to the required broken line, is prepared. By passing a porous base material, such as non-woven fabric, through this cutting device, a porous base material having the broken line-like cuts can be formed. The size, arrangement proportion, arrangement form, and the like of the cutting parts and the non-cutting parts of each of adjacent roll blades may be the same or different. Adjacent roll blades may be arranged in a manner that cuts are formed substantially symmetrical to each other as illustrated in FIG. 6(a), or may be arranged in a manner that adjacent non-cutting parts are not in a straight line in the transverse direction and cuts are formed out of alignment each other as illustrated in FIG. 6(b). From the perspective of stretchability, the adjacent roll blades are preferably arranged in a manner that adjacent non-cutting parts are not in a straight line in the transverse direction and cuts are formed out of alignment each other as illustrated in FIG. 6(b).

The production method of the thermally conductive laminate of the present disclosure is not particularly limited, and a known method can be used. For example, the thermally conductive laminate can be formed by continuously feeding the thermally conductive resin layer and the porous base material that have been prepared separately in between rolls to adhere them, or by placing the thermally conductive resin layer and the porous base material in a batch-type press laminating machine to adhere them discontinuously. Alternatively, the thermally conductive laminate can be formed by using an in-mold molding method, in which the porous base material is placed in a mold and then the resin layer is injected thereto. The thermally conductive laminate may be in a form of a roll or in a form of cut sheets.

In the production of the thermally conductive laminate, as necessary, a release liner may be applied to the surface, or punch processing may be applied to form any shape and size.

The thermally conductive laminate of the present disclosure is typically used by being inserted in between a heat-dissipating component and a heat-generating component. In such a configuration, when pressure is applied from the outside (arrow outline with a blank inside) as illustrated in FIG. 2(b), the porous base materials 204 on the both major faces are embedded in the thermally conductive resin layer 202 and the resin of the thermally conductive resin layer 202 appears on the surface of the thermally conductive laminate through holes of the porous base materials 204, and thus thermal conductivity and adhesiveness can be exhibited in between the heat-dissipating component 206 and the heat-generating component 208. In some embodiments, when applied pressure is removed from the thermally conductive laminate of the present disclosure, the resin of the thermally conductive resin layer returns from the surface to the inner part, and the adhesiveness on the surface part of the porous base material is reduced or disappears, and thus the thermally conductive laminate can be easily removed from this porous base material part.

Because the particular porous base material described above is applied to the thermally conductive resin layer in the thermally conductive laminate of the present disclosure, for example, following performances can be exhibited.

The thermally conductive laminate of the present disclosure can exhibit excellent thermal conductivity because the resin of the resin layer appears on the surface when pressure is applied from the outside of the porous base material. The thermal conductivity of the thermally conductive laminate is not particularly limited and, for example, as the thermal conductivity at 50% compression, approximately 0.8 W/mK or greater, approximately 1.0 W/mK or greater, or approximately 1.2 W/mK or greater can be achieved. The upper limit of the thermal conductivity is not particularly limited and, for example, can be approximately 10 W/mK or less, approximately 8.0 W/mK or less, approximately 6.0 W/mK or less, or approximately 4.0 W/mK or less.

The thermally conductive laminate of the present disclosure can impart adhesiveness to an adherend, such as a heat-generating component, because the resin of the resin layer appears on the surface when pressure is applied from the outside of the porous base material. The adhesiveness of the thermally conductive laminate is not particularly limited. For example, in the case where reworkability is required, a relatively weak adhesive strength may be advantageous for attaching and removing, and in the case where reworkability is not required, a relatively strong adhesive strength may be advantageous. For example, the adhesive strength at 50% compression can be approximately 1 kPa or greater, approximately 2 kPa or greater, or approximately 3 kPa or greater. The upper limit of the adhesive strength can be appropriately selected in a range of approximately 120 kPa or less, approximately 100 kPa or less, approximately 90 kPa or less, approximately 80 kPa or less, or approximately 70 kPa or less, taking the presence or absence of reworkability, for example.

Because the particular porous base material described above is applied to the thermally conductive resin layer in the thermally conductive laminate of the present disclosure, increase in internal stress depending on the force applied from the outside can be reduced or suppressed compared to configurations where non-stretchable non-woven fabric or the like is applied to the entire face. The performance can be evaluated by compressibility determined by Equation 1 below by using each compressive stress (load) of the thermally conductive laminate and the thermally conductive resin layer in a state where pressure is applied in a predetermined compression percentage.

Compressibility (%)=(compressive stress of thermally conductive laminate/compressive stress of thermally conductive resin layer)×100 Equation 1

The thermally conductive laminate of the present disclosure can achieve the compressibility at 30% compression of, for example, approximately 260% or less, approximately 255% or less, approximately 250% or less, approximately 245% or less, approximately 240% or less, or approximately 235% or less. The lower limit of the compressibility is not particularly limited, but can be approximately 101% or greater, approximately 102% or greater, or approximately 103% or greater.

The thermally conductive laminate of the present disclosure can achieve the compressibility at 50% compression of, for example, approximately 270% or less, approximately 265% or less, approximately 260% or less, approximately 255% or less, approximately 250% or less, approximately 245% or less, or approximately 240% or less. The lower limit of the compressibility is not particularly limited, but can be approximately 101% or greater, approximately 102% or greater, or approximately 103% or greater.

The thermally conductive laminate of the present disclosure can exhibit excellent restorability of dimension. It is conceived that a thermally conductive resin layer constituting a flexible thermally conductive laminate, such as a thermally conductive resin layer containing (meth)acrylic resin or silicone gel, typically exhibits viscoelasticity. For example, when the thermally conductive laminate 100 having a configuration of FIG. 1(a) is subjected to a force applied from the outside (arrow outline with a blank inside) as illustrated in FIG. 1(b), the resin around right and left edge parts of the thermally conductive resin layer 102, which are less likely to be bound by the porous base material, tends to be stretched locally. It is conceived that this resin layer part stretched locally tends to cause plastic deformation. As a result, when the thermally conductive laminate is peeled off from the adherend for rework, it is difficult for the thermally conductive laminate to return to the original form, and for example, in the use where high reworkability is required, adequate restorability of dimension may not be achieved.

Meanwhile, when the thermally conductive laminate of the present disclosure is subjected to a force applied from the outside as illustrated in FIG. 2(b), because effect of binding by the porous base material is less compared to the thermally conductive laminate having a configuration of FIG. 1, tendency of the resin around right and left edge parts of the thermally conductive resin layer being stretched locally is reduced. As a result, it is conceived that, for the stretched resin layer part, restorability involved with the elasticity becomes dominant over the plastic deformation, in the case where the thermally conductive laminate of the present disclosure is peeled off from the adherend for rework, it is easy for the thermally conductive laminate to return to the original form.

The restorability of dimension of the thermally conductive laminate can be evaluated based on dimensional change percentage determined by Equation 2 below by using a dimension of freely selected position in the planar direction of the thermally conductive laminate before compression (hereinafter, referred to as “initial dimension”) and a dimension of the same position of the thermally conductive laminate after pressure is applied at 50% compression percentage to the thermally conductive laminate and then the thermally conductive laminate is removed from the compressing device and left stationary for approximately 2 hours (hereinafter, referred to as “dimension after compression”). Note that the dimensional change percentage can be defined as an average value of at least two dimensional change percentages of at least freely selected two positions of the thermally conductive laminate, preferably at least two positions on a straight line passing through a substantially center of the thermally conductive laminate.

Dimensional change percentage (%)=(dimension after compression−initial dimension)/initial dimension×100 Equation 2

The thermally conductive laminate of the present disclosure can achieve the dimensional change percentage of, for example, approximately 20% or less, approximately 18% or less, or approximately 16% or less. The lower limit of the dimensional change percentage is not particularly limited, but can be approximately 0% or greater, approximately 0.5% or greater, or approximately 1.0% or greater.

Using this dimensional change percentage, based on dimensional enhancement percentage determined by Equation 3 below, enhancement of the dimension of the thermally conductive laminate compared to the case of the thermally conductive resin layer alone can be evaluated. Note that a higher value of the dimensional enhancement percentage indicates more enhancement of dimension enhancement performance.

Dimensional enhancement percentage (%)=(dimensional change percentage of thermally conductive resin layer−dimensional change percentage of thermally conductive laminate)/dimensional change percentage of thermally conductive resin layer×100 Equation 3

The thermally conductive laminate of the present disclosure can achieve the dimensional enhancement percentage of, for example, approximately 40% or greater, approximately 45% or greater, approximately 50% or greater, or approximately 55 or greater. The upper limit of the dimensional enhancement percentage is not particularly limited, but can be approximately 100% or less, approximately 98% or less, or approximately 95% or less.

Use of the thermally conductive laminate of the present disclosure is not particularly limited and, for example, can be used for uses that require heat radiation. The thermally conductive laminate of the present disclosure can be used in, for example, vehicles, batteries (e.g. in-car lithium ion batteries), home electrical appliances, electronic devices, and computer devices. For example, the thermally conductive laminate of the present disclosure can be advantageously used for a component applied in between a heat-generating component, such as a semiconductor package, a power transistor, a semiconductor chip (such as IC chip, LSI chip, and VLSI chip), or a central processing unit (CPU), and a heat-dissipating component, such as a heat sink or heat pipe.

The thermally conductive laminate of the present disclosure can be used by piling up two or more of the laminates depending on use, for example.

### Examples

Specific embodiments of the present disclosure will be exemplified in the following examples, but the present invention is not limited to these embodiments. All parts and percentages are based on mass unless otherwise specified.

Raw materials and the like used in the examples are shown in Table 2 below.

TABLE 1

| Trade Name or | | |
|---|---|---|
| Abbreviation | Description | Source of Supply |
| EHA | Photopolymerization component: 2-ethylhexyl | Nippon Shokubai Co., |
| | acrylate | Ltd. |
| HDDA | Crosslinking agent: 1,6-hexanediol diacrylate | Shin-Nakamura |
| | | Chemical Co., Ltd. |
| TOTM | Plasticizer: trioctyl trimellitate | Mitsubishi Chemical |
| | | Corporation |
| Omnirad (trade | Acylphosphine oxide-based photoreaction | IGM Resins B.V. |
| name) 819 | initiator | |
| Titacoat (trade | Titanate coupling agent | Nippon Soda Co., Ltd. |
| name) S-151 | | |
| Minerasol (trade | Viscosity modifier: hydroxy fatty acid | Itoh Oil Chemicals |
| name) R335 | | Co., Ltd. |
| Tinuvin (trade | Ultraviolet absorber | BASF Japan Ltd. |
| name) 405 | | |
| Silgel 612A | Vinyl group, hydrosilane-containing | Wacker Asahikasei |
| | polydimethylsiloxane mixture | Silicone Co., Ltd. |
| Silgel 612B | Vinyl group-containing polydimethylsiloxane, | Wacker Asahikasei |
| | catalyst mixture | Silicone Co., Ltd. |
| DMS-V31 | Vinyl group terminal-containing | GELEST Inc. |
| | polydimethylsiloxane | |
| AX35-125 | Thermally conductive raw material: aluminum | Nippon Steel & |
| | oxide particles having average particle diameter | Sumikin Materials |
| | of approximately 38 μm | Co., Ltd. |
| AX3-75 | Thermally conductive raw material: aluminum | Nippon Steel & |
| | oxide particles having average particle diameter | Sumikin Materials |
| | of 4.5 μm | Co., Ltd. |
| LS210B | Thermally conductive raw material: aluminum | Nippon Light Metal |
| | oxide particles having average particle diameter | Co., Ltd. |
| | of approximately 3 μm | |
| B53 | Thermally conductive raw material: aluminum | Nippon Light Metal |
| | hydroxide having average particle diameter of | Co., Ltd. |
| | approximately 55 μm | |
| BF083 | Thermally conductive raw material: aluminum | Nippon Light Metal |
| | hydroxide having average particle diameter of | Co., Ltd. |
| | approximately 10 μm | |
| GLASPER GMC- | Glass fiber non-woven fabric having basis | Oji F-Tex Co., Ltd. |
| 10-MR5 | weight of approximately 11 g/m² | |
| Cerex (trade | Polyamide fiber non-woven fabric having basis | CEREX Advanced |
| name) 23030 | weight of approximately 10 g/m² | Fabrics Inc. |
| Orion (trade | Polyamide fiber non-woven fabric having basis | CEREX Advanced |
| name) 70030 | weight of approximately 10 g/m² | Fabrics Inc. |
| MILIFE (trade | Polyester fiber non-woven fabric having basis | JX Nippon ANCI |
| name) 0503FE | weight of approximately 8 g/m² | Corporation |
| MILIFE (trade | Polyester fiber non-woven fabric having basis | JX Nippon ANCI |
| name) 1010FE | weight of approximately 20 g/m² | Corporation |
| MILIFE (trade | Polyester fiber non-woven fabric having basis | JX Nippon ANCI |
| name) 2020FE | weight of approximately 40 g/m² | Corporation |

The raw materials shown in Table 1 were mixed in blending proportions shown in Table 2 to prepare each thermally conductive resin composition for thermally conductive resin layer preparation. The numerical values in Table 2 are all in units of parts by mass.

TABLE 2

| | | Thermally conductive resin | | |
|---|---|---|---|---|
| | | composition | | |
| Components | | 1 | 2 | 3 |
| Photopolymerizable | EHA | 100 | 100 | — |
| acrylic component | | | | |
| Crosslinking agent | HDDA | 0.2 | 0.2 | — |
| Plasticizer | TOTM | 90 | 150 | — |
| Photoreaction | Omnirad (trade | 0.4 | 0.4 | — |
| initiator | name) 819 | | | |
| Coupling agent | Titacoat (trade | 3 | 3 | — |
| | name) S-151 | | | |
| Viscosity modifier | Minerasol | 2 | 5 | — |
| | (trade name) | | | |
| | R335 | | | |
| Ultraviolet absorber | Tinuvin (trade | 3 | 3 | — |
| | name) 405 | | | |
| Silicone-based raw | Silgel 612A | — | — | 50 |
| material | Silgel 612B | — | — | 50 |
| | DMS-V31 | — | — | 9 |
| Thermally | AX35-125 | 400 | — | 660 |
| conductive raw | AX3-75 | — | — | 220 |
| material | LS210B | 400 | — | — |
| | B53 | 500 | 450 | — |
| | BF083 | | 600 | — |

### Comparative Example 1

The thermally conductive resin composition 1 prepared in blending proportions shown in Table 2 was provided in between two sheets of transparent polyethylene terephthalate (PET) liners (thickness: approximately 50 μm) that were treated separately with a silicone release agent, and calender-molded into a sheet shape. Thereafter, while the sheet of the thermally conductive resin composition was held inside the two sheets of PET liners, each of the both faces of the sheet was irradiated with ultraviolet radiation of irradiation intensity of 0.3 mW/cm² for 6 minutes per face and then continuously irradiated with ultraviolet radiation of irradiation intensity of 7.0 mW/cm² for 10 minutes per face, and thus an acrylic thermally conductive resin sheet having a thickness of approximately 2 mm was prepared. Then, the sheet was cut into a size of approximately 25 mm×approximately 25 mm, and thus a thermally conductive resin sheet of Comparative Example 1 was prepared.

### Comparative Examples 2 to 6

On the both faces of the thermally conductive resin sheet of Comparative Example 1, non-woven fabric as a porous base material shown in Table 3 was adhered to the entire face, and thus each of the thermally conductive laminates of Comparative Examples 2 to 6 was prepared.

### Examples 1 to 4 and Comparative Examples 7 and 8

As illustrated in FIG. 3, non-woven fabric having a predetermined width shown in Table 3 (GLASPER GMC-10-MR5) was adhered symmetrically in a substantially central part of the both faces of the thermally conductive resin sheet of Comparative Example 1, and thus each of the thermally conductive laminates of Examples 1 to 4 and Comparative Examples 7 and 8 was prepared.

### Examples 5 and 6 and Comparative Example 9

As illustrated in FIG. 4, non-woven fabric having a predetermined width shown in

Table 3 (GLASPER GMC-10-MR5) was adhered symmetrically in both edge parts of the both faces of the thermally conductive resin sheet of Comparative Example 1, and thus each of the thermally conductive laminates of Examples 5 and 6 and Comparative Example 9 was prepared.

### Comparative Example 10

The thermally conductive resin sheet of Comparative Example 10 was prepared in the same manner as in Comparative Example 1 except for using the thermally conductive resin composition 2 prepared in blending proportions of Table 2.

### Comparative Example 11

On the both faces of the thermally conductive resin sheet of Comparative Example 10, non-woven fabric (Cerex (trade name) 23030) shown in Table 3 was adhered to the entire face, and thus the thermally conductive laminate of Comparative Example 11 was prepared.

### Examples 7 and 8

As illustrated in FIG. 3, non-woven fabric having a predetermined width shown in Table 3 (Cerex (trade name) 23030) was adhered symmetrically in a substantially central part of the both faces of the thermally conductive resin sheet of Comparative Example 10, and thus each of the thermally conductive laminates of Examples 7 and 8 was prepared.

### Examples 9 to 11

As illustrated in FIG. 4, non-woven fabric having a predetermined width shown in Table 3 (Cerex (trade name) 23030) was adhered symmetrically in both edge parts of the both faces of the thermally conductive resin sheet of Comparative Example 10, and thus each of the thermally conductive laminates of Examples 9 to 11 was prepared.

### Examples 12 to 15 and Comparative Example 12

A cutting device was prepared, in which a plurality of roll blades, each blade being capable of forming cut parts of approximately 5 mm and non-cut parts of 1 mm alternately, were arranged in a manner that pitch distance in the transverse direction (TD) was approximately 2 mm and in a manner that adjacent cuts were formed out of alignment each other. Each of the non-woven fabric shown in Table 3 was inserted into this device, and thus a non-woven fabric having broken line-like cuts, cuts being formed out of alignment each other in a manner that adjacent non-cut parts were not in a straight line in the transverse direction, as illustrated in FIG. 6(b), was prepared. As illustrated in FIG. 5(a), each of the obtained non-woven fabrics was adhered to the both faces of the thermally conductive resin sheet of Comparative Example 1, and thus each of the thermally conductive laminates of Examples 12 to 15 and Comparative Example 12 was prepared. Note that the used non-woven fabric had a lattice-like form such as a form illustrated in FIG. 5(b) when the non-woven fabric was stretched in the vertical direction relative to the lines of cuts.

### Comparative Example 13

In a planetary centrifugal mixer, 50 parts by mass of Silgel 612A, 9 parts by mass of DMS-V31, 220 parts by mass of spherical alumina AX3-75, and 660 parts by mass of spherical alumina AX35-125 were charged and agitated at 2000 rpm for 2 minutes. Then, 50 parts by mass of Silgel 612B was added and agitated at 2000 rpm for 1 minute and then degassed for 1 minute, and thus a thermally conductive resin composition 3 was prepared. This thermally conductive resin composition 3 was inserted in between two sheets of transparent PET liners (thickness: approximately 50 μm), calender-molded into a sheet shape, left stationary in a constant temperature bath at 70° C. for 30 minutes, and thus a silicone-based thermally conductive resin sheet having a thickness of approximately 2 mm was prepared.

### Comparative Example 14

On the both faces of the thermally conductive resin sheet of Comparative Example 13, non-woven fabric (Orion (trade name) 70030) shown in Table 3 was adhered to the entire face, and thus the thermally conductive laminate of Comparative Example 14 was prepared.

### Examples 16 and 17

As illustrated in FIG. 3, non-woven fabric having a predetermined width shown in Table 3 (Orion (trade name) 70030) was adhered symmetrically in a substantially central part of the both faces of the thermally conductive resin sheet of Comparative Example 13, and thus each of the thermally conductive laminates of Examples 16 and 17 was prepared.

The properties of the thermally conductive resin sheets and the thermally conductive laminates of Examples 1 to 17 and Comparative Examples 1 to 14 were evaluated in accordance with the following methods. The results are shown in Table 3. Note that “application proportion (%) of porous base material” in Table 3 means an applied proportion of the porous base material relative to the total area of the major faces of the thermally conductive resin sheet.

### Evaluation Method

### Evaluation of Asker C Hardness

A test sample having a thickness of approximately 10 mm was prepared by piling 5 sheets each of the thermally conductive resin sheets of Comparative Examples 1, 10, and 13. The Asker C hardness of this test sample was measured by using ASKER Rubber Hardness Tester Type C (available from Kobunshi Keiki Co., Ltd.) in accordance with SRIS0101, which is a standard specification of the Society of Rubber Science and Technology, Japan.

### Evaluation of Thermal Conductivity

The measurement of thermal conductivity was performed in accordance with a measurement method of thermal resistance/thermal conductivity of ASTM D5470 by using a thermal resistance tester (TIM Tester 1400, available from Analysis Tech, Inc.). A disk-like test sample, obtained by punching out into a disk having a diameter of approximately 33 mm, was inserted in between a heater and a cooling plate of the thermal resistance tester, and a load of 100 kPa was then applied to measure the thermal conductivity.

### Evaluation of Compressive Stress

The compressive stress was measured by a universal tester using a jig having a size of 35 mm×40 mm. A test sample having 25 mm length×25 mm width×2 mm thickness was placed in the universal tester in a manner that the test sample was positioned in a substantially center of the jig, the jig equipped to a load meter was moved downward at a rate of 0.5 mm/min, and the load at which the test sample was compressed by 30% (compressive stress) was measured. Then, the load at which the test sample was compressed by 50% (compressive stress) was also measured.

Using each of the compressive stresses of the thermally conductive sheet and the thermally conductive laminate prepared by using the sheet, the compressibility was calculated by Equation 1 below, and the results are shown in Table 3.

Compressibility (%)=(compressive stress of thermally conductive laminate/compressive stress of thermally conductive sheet)×100 Equation 1

### Evaluation of Tensile Adhesion Strength

A test sample having 25 mm length x 25 mm width x 2 mm thickness was placed in substantially central part between two sheets of steel sheets and compressed to 50% by pressing. Then, plane parts of stainless steel blocks each having a plane part of 30 mm×30 mm and a T-shaped cross section were adhered substantially symmetrically in substantially central parts of the two sheets of the steel sheets by using a 3M (trade name) VHB (trade name) adhesive tape for acrylic foam structure BR-12. Thereafter, by pulling the steel sheets by gripping the protruded parts of the T-shaped blocks protruded in substantially vertical direction relative the plane parts by using the universal tester, the tensile adhesion strength (plane tensile adhesion strength) was measured. The pulling speed was 5 mm/min.

### Evaluation of Dimensional Change Percentage

The test sample having 25 mm length×25 mm width×2 mm thickness as the initial dimension was placed on a steel sheet and compressed by pressing to 50%. Thereafter, the test sample was peeled off from one steel sheet by pulling the other steel sheet at a rate of 5 mm/min, and then the test sample was gradually peeled off by 90° peel condition from the steel sheet in a manner that the test sample was not cut. After the peeled test sample was left stationary for approximately 2 hours, length of each of the length direction and the transverse direction of the test sample (dimension after compression) was measured, and each dimensional change percentage was calculated by Equation 2 below. The results are shown in Table 3. Table 3 also shows the average value calculated from the dimensional change percentages of the length direction and the transverse direction.

Dimensional change percentage (%)=(dimension after compression−initial dimension)/initial dimension×100 Equation 2

### Evaluation of Dimensional Enhancement Percentage

The dimensional enhancement percentage was calculated using the average value of the dimensional change percentages by Equation 3 below, and the results are shown in Table 3. Note that the dimensional change percentage of the thermally conductive resin layer means the dimensional change percentages of Comparative Examples 1, 10, or 13, to which no porous base material was applied.

Dimensional enhancement percentage (%)=(dimensional change percentage of thermally conductive resin layer−dimensional change percentage of thermally conductive laminate)/dimensional change percentage of thermally conductive resin layer×100 Equation 3

TABLE 3

| | | Porous base material (non-woven fabric) | | | | | | |
|---|---|---|---|---|---|---|---|---|
| | | | Basis | | | Application | Thermal | Load at 30% |
| | Asker C | | weight | Application | Width | proportion | conductivity | compression |
| | hardness | Type | (g/m²) | Position | (mm) | (%) | (W/mK) | (N) |
| Comparative | 5 | — | — | — | — | 100− | 1.90 | 60 |
| Example 1 | | | | | | | | |
| Comparative | 5 | GMC | 11 | Entire face | — | 100− | 1.81 | 198 |
| Example 2 | | | | | | | | |
| Comparative | 5 | Cerex | 10 | Entire face | — | 100− | 1.82 | 171 |
| Example 3 | | | | | | | | |
| Comparative | 5 | 0503FE | 8.0 | Entire face | — | 100− | 1.81 | 220 |
| Example 4 | | | | | | | | |
| Comparative | 5 | 1010FE | 20 | Entire face | — | 100− | 1.65 | 233 |
| Example 5 | | | | | | | | |
| Comparative | 5 | 2020FE | 40 | Entire face | — | 100− | 1.15 | 178 |
| Example 6 | | | | | | | | |
| Example 1 | 5 | GMC | 11 | Center | 2.5 | 10 | 1.81 | 69 |
| Example 2 | 5 | GMC | 11 | Center | 5.0 | 20 | 1.81 | 71 |
| Example 3 | 5 | GMC | 11 | Center | 10 | 40 | 1.81 | 90 |
| Example 4 | 5 | GMC | 11 | Center | 15 | 60 | 1.81 | 99 |
| Comparative | 5 | GMC | 11 | Center | 20 | 80 | 1.81 | 161 |
| Example 7 | | | | | | | | |
| Comparative | 5 | GMC | 11 | Center | 22.5 | 90 | 1.81 | 192 |
| Example 8 | | | | | | | | |
| Example 5 | 5 | GMC | 11 | Both edges | 2.5 | 20 | 1.81 | 80 |
| Example 6 | 5 | GMC | 11 | Both edges | 5.0 | 40 | 1.81 | 82 |
| Comparative | 5 | GMC | 11 | Both edges | 10 | 80 | 1.81 | 166 |
| Example 9 | | | | | | | | |
| Comparative | 5 | — | — | — | — | — | 1.75 | 49 |
| Example 10 | | | | | | | | |
| Comparative | 5 | | 10 | Entire face | — | 100 | 1.67 | 294 |
| Example 11 | | | | | | | | |
| Example 7 | 5 | Cerex | 10 | Center | 5.0 | 20 | 1.73 | 83 |
| Example 8 | 5 | Cerex | 10 | Center | 10 | 40 | 1.71 | 114 |
| Example 9 | 5 | Cerex | 10 | Both edges | 3.0 | 24 | 1.72 | 62 |
| Example 10 | 5 | Cerex | 10 | Both edges | 6.0 | 48 | 1.70 | 100 |
| Example 11 | 5 | Cerex | 10 | Both edges | 9.0 | 72 | 1.68 | 125 |
| Example 12 | 5 | GMC | 11 | Entire face | — | 100 | 1.81 | 147 |
| | | | | (broken line) | | | | |
| Example 13 | 5 | Cerex | 10 | Entire face | — | 100 | 1.82 | 105 |
| | | | | (broken line) | | | | |
| Example 14 | 5 | 0503FE | 8.0 | Entire face | — | 100 | 1.81 | 148 |
| | | | | (broken line) | | | | |
| Example 15 | 5 | 1010FE | 20 | Entire face | — | 100 | 1.65 | 137 |
| | | | | (broken line) | | | | |
| Comparative | 5 | 2020FE | 40 | Entire face | — | 100 | 1.15 | 171 |
| Example 12 | | | | (broken line) | | | | |
| Comparative | 10 | Orion | 10 | — | — | — | 2.20 | 129 |
| Example 13 | | | | | | | | |
| Comparative | 10 | Orion | 10 | Entire face | — | 100 | 2.17 | 337 |
| Example 14 | | | | | | | | |
| Example 16 | 10 | Orion | 10 | Center | 7.5 | 30 | 2.19 | 134 |
| Example 17 | 10 | Orion | 10 | Center | 17.5 | 70 | 2.18 | 181 |

| | | | | | Dimensional | | | |
|---|---|---|---|---|---|---|---|---|
| | | | | Tensile | charge | | | Dimensional |
| | 30% | Load at 50% | 50% | adhesion | percentage | | | enhancement |
| | compressibility | compression | Compressibility | strength | (%) | | | percentage |
| | (% ) | (N) | (%) | (kPa) | MD | TD | Average | (%) |
| Comparative | — | 161 | — | 137 | 36 | 36 | 36 | — |
| Example 1 | | | | | | | | |
| Comparative | 330 | 570 | 354 | 55 | 24 | 28 | 26 | 28 |
| Example 2 | | | | | | | | |
| Comparative | 285 | 460 | 286 | 28 | 20 | 24 | 22 | 39 |
| Example 3 | | | | | | | | |
| Comparative | 367 | 554 | 344 | 61 | 24 | 28 | 26 | 28 |
| Example 4 | | | | | | | | |
| Comparative | 388 | 656 | 407 | 16 | 24 | 24 | 24 | 33 |
| Example 5 | | | | | | | | |
| Comparative | 297 | 468 | 291 | 10 | 28 | 32 | 30 | 17 |
| Example 6 | | | | | | | | |
| Example 1 | 115 | 173 | 107 | 83 | 10 | 17 | 13 | 64 |
| Example 2 | 118 | 180 | 112 | 97 | 6.7 | 10 | 8.3 | 77 |
| Example 3 | 150 | 240 | 149 | 77 | 11 | 12 | 11 | 69 |
| Example 4 | 165 | 282 | 175 | 38 | 12 | 12 | 12 | 67 |
| Comparative | 268 | 504 | 313 | 25 | 18 | 17 | 18 | 50 |
| Example 7 | | | | | | | | |
| Comparative | 320 | 614 | 381 | 37 | 21 | 21 | 21 | 42 |
| Example 8 | | | | | | | | |
| Example 5 | 133 | 213 | 132 | 95 | 10 | 15 | 12 | 67 |
| Example 6 | 137 | 209 | 130 | 79 | 13 | 20 | 17 | 53 |
| Comparative | 277 | 457 | 248 | 53 | 23 | 37 | 30 | 17 |
| Example 9 | | | | | | | | |
| Comparative | — | 142 | — | 86 | 16 | 10 | 13 | — |
| Example 10 | | | | | | | | |
| Comparative | 600 | 724 | 510 | 10 | 9.1 | 9.1 | 9.1 | 30 |
| Example 11 | | | | | | | | |
| Example 7 | 169 | 232 | 163 | 89 | 2.5 | 0.1 | 1.3 | 90 |
| Example 8 | 233 | 304 | 214 | 23 | 2.9 | 1.6 | 2.3 | 82 |
| Example 9 | 129 | 184 | 130 | 64 | 1.6 | 0 | 0.8 | 94 |
| Example 10 | 204 | 275 | 194 | 50 | 0.1 | 1.4 | 0.8 | 94 |
| Example 11 | 255 | 333 | 235 | 38 | 3.2 | 4.9 | 4.0 | 69 |
| Example 12 | 245 | 325 | 202 | 73 | 16 | 16 | 16 | 56 |
| Example 13 | 175 | 268 | 166 | 85 | 16 | 20 | 18 | 50 |
| Example 14 | 247 | 379 | 235 | 54 | 16 | 20 | 18 | 56 |
| Example 15 | 228 | 337 | 234 | 3.0 | 20 | 20 | 20 | 44 |
| Comparative | 285 | 466 | 289 | 3.0 | 24 | 28 | 26 | 28 |
| Example 12 | | | | | | | | |
| Comparative | — | 497 | — | 82 | 6.0 | 6.0 | 6.0 | — |
| Example 13 | | | | | | | | |
| Comparative | 261 | 900 | 181 | 1.5 | 2.0 | 2.0 | 2.0 | 67 |
| Example 14 | | | | | | | | |
| Example 16 | 104 | 551 | 103 | 43 | 0.0 | 0.0 | 0.0 | 100 |
| Example 17 | 140 | 632 | 127 | 4.0 | 0.0 | 2.0 | 1.0 | 83 |

It will be apparent to those skilled in the art that various modifications can be made to the embodiments and the examples described above without departing from the basic principles of the present invention. In addition, it will be apparent to those skilled in the art that various improvements and modifications of the present invention can be carried out without departing from the spirit and the scope of the present invention.

### Reference Signs List

100, 200, 300, 400, 500 Thermally conductive laminate

102, 202, 302, 402, 502 Thermally conductive resin layer

104, 204, 304, 404, 504 Porous base material

505 Cut

106, 206 Heat-dissipating component

108, 208 Heat-generating component

1. A thermally conductive laminate comprising:
a thermally conductive resin layer containing a thermally conductive raw material and a resin and having first and second major faces; and
a porous base material provided on at least one of the first and second major faces of the thermally conductive resin layer,
the porous base material being arranged in a proportion of 75% or less relative to a total area of the major faces of the thermally conductive resin layer to which the base material is arranged.

2. The laminate according to claim 1, wherein a basis weight of the porous base material is from 1.0 g/m² to 20 g/m².

3. The laminate according to claim 1, wherein an Asker C hardness of the thermally conductive resin layer is from 0.1 to 15.

4. The laminate according to claim 1, wherein the porous base material is arranged at least in a substantially central part of one of the major faces of the thermally conductive resin layer.

5. The laminate according to claim 1, wherein the porous base material is arranged separately at at least two positions in a substantially peripheral part of one of the major faces of the thermally conductive resin layer.

6. The laminate according to claim 1, wherein the porous base material is arranged on the both first and second major faces of the thermally conductive resin layer.

7. The laminate according to claim 1, wherein the laminate is substantially rectangle.

8. The laminate according to claim 1, wherein the resin is a (meth)acrylic resin.

9. The laminate according to claim 1, wherein a thermal conductivity at 50% compression is 0.8 W/mK or greater.

10. A thermally conductive laminate comprising:
a thermally conductive resin layer containing a thermally conductive raw material and a resin and having first and second major faces; and
a porous base material provided on at least one of the first and second major faces of the thermally conductive resin layer,
a compression ratio at 30% compression being 260% or less.
